(19) United States
(12) Patent Application Publication
(10) Pub. No.: US 2014/0203028 A1
(43) Pub. Date: Jul. 24, 2014

(54) COLLAPSIBLE SELF-SUPPORTING WALL SOCKET APPLIANCE CHARGING AND STORAGE CADDY

(71) Applicant: Roman Moroz, Etobicoke (CA)

(72) Inventor: Roman Moroz, Etobicoke (CA)

(21) Appl. No.: 13/745,337

(22) Filed: Jan. 18, 2013

(51) Int. Cl. F16M 13/00

(52) U.S. Cl. CPC F16M 13/00
USPC 220/661

(57) ABSTRACT

The present invention provides a collapsible self-supporting wall socket caddy used to hold an appliance and charger cord at a wall socket to facilitate charging the appliance. The caddy comprises a back panel with an opening allowing the appliance charger contacts to pass through the caddy and engage in the wall socket, thereby securing the caddy to the wall socket. The caddy also comprises front, bottom and two side panels forming the appliance and charger cord holder of the caddy. The caddy is collapsible for, storage, and packing for travel. The caddy can also engage a protruding object comprising a hook, door knob, screw, nail, rod or the like; for the purpose of charging an appliance in close proximity to a wall socket, to allow the charger to engage the wall socket and the charger cord to connect to the appliance in the caddy holder; or to store the caddy and appliance.

### FIELD OF THE INVENTION

The present invention relates to a charging holder and storage device and more particularly to a collapsible self-supporting wall socket appliance charging and storage caddy.

### BACKGROUND OF THE INVENTION

With the advancement of modern technology, rechargeable appliances have become very common and popular. Such appliances, more commonly referred to as mobile phones, portable audio devices, compact digital cameras, remote controls, portable meters and the like; and often powered by an internal power source, which source requires to be recharged when the internal power source is depleted. To recharge such appliances a charger is required and is typically supplied with the appliance upon purchase. The charger is comprised of a charging device that is housed in a small case with protruding contacts and a fixed length cord that attaches to the appliance. To charge the appliance a wall socket is required as well as a place to rest the appliance during the charging state. This requires that a suitable resting surface be in close proximity to the wall socket to accommodate the appliance in a safe and secure manner during charging. At times a wall socket may not be in a close proximity to a suitable resting surface to charge the appliance. This can often be the case in a home where a wall socket is positioned away from furniture, an office, a temporary residence during travel or a hotel room; a public waiting area as found in an airport, bus terminal or train station where walls sockets are often located on a wall or post at varying heights; a construction site or structure under renovation, or any structure where the wall socket placement is such that the length of the charger cord is not long enough to reach a suitable resting surface or a suitable resting surface is not available. In the case of the later, where a suitable resting surface is not available, an appliance may also require to be stored safely and securely in a state other than during charging. If no such surface is available, as is commonplace within an unfinished structure during construction or a structure during renovation, an appliance could be more susceptible to damage esthetically, functionally or both, thus resulting in possible repair costs and loss of use and/or enjoyment.

A self supporting caddy that is collapsible for convenient space saving storage and packing for travel and that provides a safe and secure means of charging and storing an appliance where a suitable resting surface is not available is thus highly desirable.

Therefore, it is an objective of the invention to provide a caddy to mitigate and obviate the problems mentioned above.

### SUMMARY AND OBJECTIVES OF THE INVENTION

The present invention provides a self supporting caddy comprising a back panel with an opening towards the top to allow the caddy to engage a wall socket by means of a charger, or to engage a protruding object (protruding object comprising a hook, door knob shaft, screw, nail, pipe, rod or the like, hereinafter referred to as “protruding object”), and a bottom panel, front panel, and right and left side panels to form a receiving area, or holder, for the appliance and charger cord.

An objective of the present invention is to provide a caddy to hold an appliance at a wall socket for the purpose of charging the appliance.

Another objective of the caddy is to engage the caddy on a protruding object in close proximity to a wall socket to allow the charger to engage the wall socket and the charger cord to connect to the appliance secured in the holder portion of the caddy.

A further objective of the caddy is to provide storage for the excess charger cord during appliance charging and storage.

A further objective of the caddy is to engage the caddy on a protruding object for the purpose of storing an appliance in the holder portion of the caddy.

A further objective of the caddy is to engage the caddy on a protruding object for the purpose of storing the caddy.

A further objective of the caddy is to provide a collapsible, storable, and self-restorable appliance holder to save space during storage and when packed for travel.

A further objective of the caddy is to provide a secure and safe way of holding an appliance when a suitable resting surface is not available.

### BRIEF DESCRIPTION OF THE DRAWINGS

An embodiment of the present invention and how they may be put into effect, by way of example, can be better understood by referring to the accompanying drawings in which:

FIG. 1 is a perspective front view showing the caddy in accordance with the present invention;

FIG. 2 is a back view of FIG. 1 showing the back panel of the caddy with the opening cut out and rounded top;

FIG. 3 is a side view of FIG. 1 showing the side edge of the back panel, and the side panel of the holder portion of the caddy;

FIG. 4 is a bottom view of FIG. 1 showing the bottom panel of the holder portion of the caddy;

FIG. 5 is a top view of FIG. 1 showing the top edges of the back, front, left side and right side panels, the bottom panel contained within these panels;

FIG. 6 is a perspective front view showing the caddy in a collapsed state for ease of storage and for packing in a space saving manner;

FIG. 7 is a top view of FIG. 6 showing the top edges of the back, front, left side and right side panels, the bottom panel contained within these panels;

FIG. 8 is a detailed perspective front view showing one embodiment of the present invention, the caddy holding an appliance and excess charger cord as the protruding contacts of the charger pass through the opening of the caddy and engage the wall socket to support the caddy to the wall socket;

FIG. 9 is a detailed perspective front view showing another embodiment of the present invention, the caddy holding an appliance and excess charger cord and supported by the charger which is fully engaged in the wall socket through the opening of the caddy;

FIG. 10 is a perspective front view showing another embodiment of the present invention, the caddy holding an appliance for the purpose of storing the appliance, and engaged on a nail protruding from a support structure;

FIG. 11 is a perspective front view showing another embodiment of the present invention, the caddy engaged on a hook for the purpose of storing the caddy;

### DETAILED DESCRIPTION

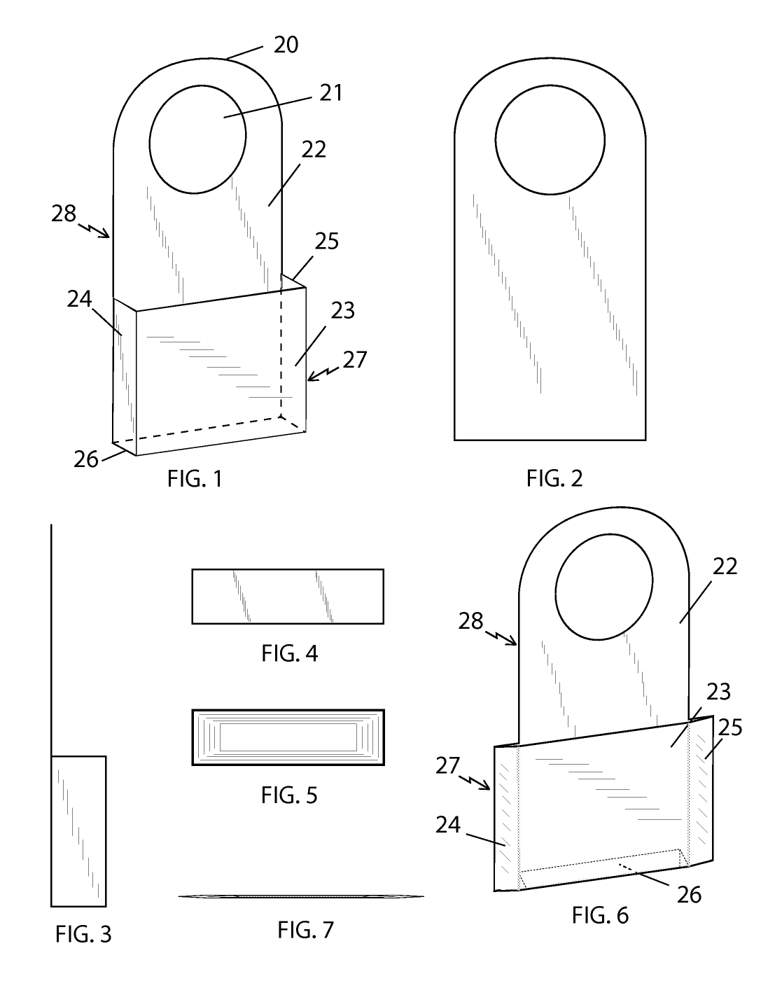

With reference to FIG. 1, an embodiment of the present invention is comprised of a single sheet of material, cut by mechanical means to form a rounded top (20) and opening (21) on the back panel (22), folded to form a back panel (22), a bottom panel (26), a front panel (23), a left side panel (24) and a right side panel (25), the bottom panel (26) joining the back panel (22) by a fold at right angle and joining the front panels (23) by a fold at right angle, the back panel (22) and front panel (23) being joined by the laterally positioned left side panel (24) and right side panel (25), the left side panel (24), joined to the front panel (23) by a fold, extending at right angle from the left side of the front panel (23) to the left side of the back panel (22) and joining the back panel at a right angle and preferably by mechanical means, the right side panel (25), joined to the front panel (23) by a fold, extending at right angle from the right side of the front panel (23) to the right side of the back panel (22) and joining the back panel at a right angle and preferably by mechanical means.

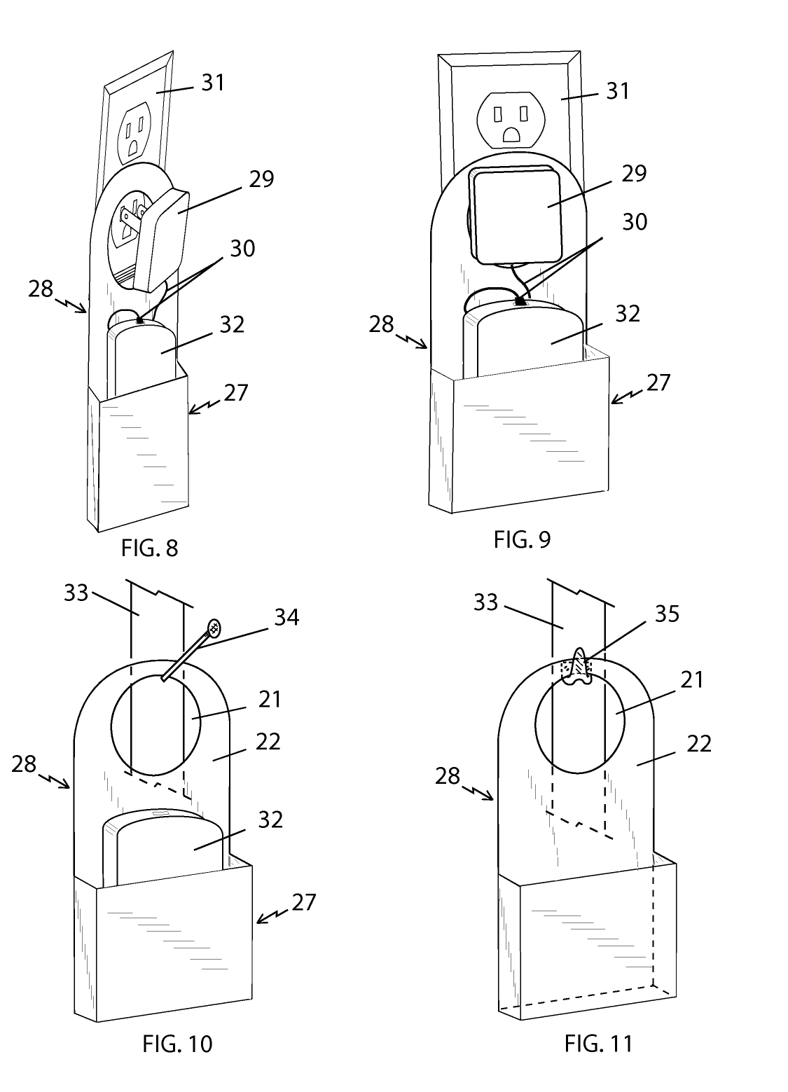

A holder (27) is formed, comprising a back panel, a front panel, a bottom panel, a left side panel, and a right side panel as part of the caddy (28); so as to hold and store an appliance and excess charger cord at a suitable distance below the opening (21), so as to allow for the protruding contacts of an appliance charger to pass through the opening (21) and engage in the wall socket (31) as shown in the preferred configuration in FIG. 8, thereby securing the caddy (28) to the wall socket (31) without the need for any additional securing hardware, as shown in the preferred configuration in FIG. 9.

With reference to FIG. 7, the caddy (28) collapsed for storage and packing for travel in a space saving manner is demonstrated. The left side panel (24) and right side panel (25) have a pre-formed crease in the center of and running along the height of each respective panel to form a hinge to allow the respective panels to collapse outward in a self-restorable manner, when pressure is applied to the front panel (23) in the direction of the back panel (22); the bottom panel (26) has a pre-formed crease in the center of and running along the length of the panel to form a hinge to allow the bottom panel to collapse inward in a self-restorable manner, when pressure is applied to the front panel (23) in the direction of the back (22); thereby collapsing the holder (27) portion of the caddy (28).

With reference to FIG. 10, the caddy (28) engaging a protruding object for the purpose of storing an appliance (32) is demonstrated. The back panel (22) is engaged on a nail (34), nail (34) being a protruding object commonplace within an unfinished structure during construction. The nail (34) passes through opening (21) providing a point of engagement for the caddy (28) at the base of nail (34) where nail (34) is affixed to a support (33). The appliance (32) is secured and stored in the holder (27) portion of the caddy (28).

With reference to FIG. 11, the caddy (28) engaging a protruding object for the purpose of storage of the caddy (28) is demonstrated. The back panel (22) is engaged on a hook (35), hook (35) being a protruding object commonplace within a structure and used for hanging. The hook (35) passes through opening (21) providing a point of engagement for caddy (28) at the base of hook (35).

What is claimed is:

1. A self supporting caddy for charging and storing an appliance comprising:
a holder for an appliance having;
a back panel with a rounded top and an opening towards the top;
a bottom panel;
a front panel;
a left side panel;
a right side panel

2. The caddy of claim 1, wherein a single sheet of material, cut by mechanical means to form a rounded top and opening on the back panel, folded to form a back panel, a bottom panel, a front panel, a left side panel and a right side panel.

3. The caddy of claim 2, wherein the bottom panel joins the bottom of the back panel and front panels by a fold at each adjoining panel, the back panel and front panel being joined on the left side and right side by the laterally positioned left side panel and right side panel respectfully, to form a holder with; a predetermined distance between said back panel and said front panel, a predetermined distance between said left side panel and said right side panel, said distance sufficient to permit an appliance and excess charger cord to be contained within.

4. The caddy of claim 1, wherein the opening towards the top of the back panel, said opening a sufficient diameter, allows for a protruding object to pass through the opening, thereby securing the caddy without the need for additional securing hardware.

5. The caddy of claim 1, wherein the opening towards the top of the back panel, said opening a sufficient distance above the holder portion of the caddy, allows for the protruding contacts of an appliance charger to pass through said opening and engage in a wall socket, thereby securing the caddy to the wall socket without the need for additional securing hardware.

6. The caddy of claim 4, wherein the holder portion of the caddy, said holder portion a sufficient distance below the opening towards the top of the back panel, allows for the appliance and excess charger cord to rest in the holder without impeding on the appliance charger when fully engaged in the wall socket.

7. The caddy of claim 4, wherein the opening towards the top of the back panel allows for the caddy to engage a protruding object for the purpose of storing an appliance.

8. The caddy of claim 4, wherein the opening towards the top of the back panel allows for the caddy to engage a protruding object for the purpose of storing the caddy.

9. The caddy of claim 1, wherein the, left side panel, right side panel, and bottom panel contain a pre-determined crease to form a hinge on each respective panel to allow said panels to fold at the hinge to allow the front panel of the holder portion of the caddy to collapse inward against the back panel.

10. The caddy of claim 9, wherein the caddy can be stored in a space saving manner.

11. The caddy in claim 9, wherein the caddy can be packed for travel in a space saving manner.
